(19) United States
(12) Patent Application Publication
(10) Pub. No.: US 2005/0126135 A1
(43) Pub. Date: Jun. 16, 2005

(54) Gas flow arrangement apparatus and to apparatus for removing pollutants from gas streams

(76) Inventor: Peter Kukla, Manchester (GB)

Correspondence Address: MICHAEL BEST & FRIEDRICH, LLP, 100 E WISCONSIN AVENUE, MILWAUKEE, WI, 53202, US

(21) Appl. No.: 10/506,442

(22) PCT Filed: Mar. 3, 2003
(86) PCT No.: PCT/GB03/00854

(30) Foreign Application Priority Data
Mar. 1, 2002 (GB) 0204928.6
Mar. 1, 2002 (GB) 0204929.4
Jul. 13, 2002 (GB) 0216302.0

(51) Int. Cl. B01D 46/00

(52) U.S. Cl. 55/309

(57) ABSTRACT

There is disclosed a gas flow arrangement apparatus comprising a gas entrance (18) and a gas exit (20), a first flow path from the gas entrance to the gas exit through a means (24) for at least partly removing at least one pollutant from a gas flow stream and second flow path from the gas entrance to the gas exit other than through the removing means (24).

### FIELD OF THE INVENTION

The present invention relates to gas flow arrangement apparatus and to pollutant removal devices, which may incorporate such gas flow arrangements.

### BACKGROUND TO THE INVENTION

Pressure is continuing to grow on vehicle manufacturers to reduce the amount of pollutants, especially particulates in gas streams emitted from vehicle exhausts. Attempts have been made to collect particulates from gas streams using electro-static precipitation, but generally these fail because the performance of the apparatus degrades substantially over time so it cannot be used in a practical environment.

The present invention finds particular, but not exclusive, application in the field of the removal of pollutants from vehicle exhaust gas streams. In this technological application, often a filter is used to remove pollutants, especially particulate pollutants. However, as particulate material is built up in the filter, the porosity of the filter decreases thus increasing back pressure on the exhaust system which can reduce engine efficiency. Since environmental concerns are the primary reason for removing pollutants, such a decrease in efficiency, with a resultant increase in pollutants, defeats the object of many such proposed filtration devices.

One particular problem area is in relation to the particulate material that is agglomerated. For instance, in a prior art electro-static precipitation apparatus of this type, a central electrode is mounted within a circular cylindrical solid-walled tube, whereby particulates are charged by the electrode and attracted to the solid-walled container. However, once particulates arrive at the tube wall over time they agglomerate and can eventually be swept out through the vehicle exhaust by the continued flow of exhaust gas flow stream over the agglomerated particulate.

In other prior art devices filters have been proposed to remove particulates from gas streams. However, in this case over time particulate build up in the filters reduces their efficiency and causes back-pressure reducing engine efficiency also.

It is an aim of preferred embodiments of the present invention to obviate or overcome at least one disadvantage of the prior art, whether referred to herein or otherwise.

### SUMMARY OF THE INVENTION

According to the present invention in a first aspect, there is provided a gas flow arrangement apparatus comprising a gas entrance and a gas exit, a first flow path from the gas entrance to the gas exit through a means for at least partly removing at least one pollutant from a gas flow stream and second flow path from the gas entrance to the gas exit other than through the removing means.

Suitably, gas passing through the pollutant removing means intersects the first gas flow.

Thus pressure differences can be minimised and undue back pressure is avoided. To the extent that gas is blocked from a first it can follow the second flow path avoiding the filter.

Suitably, the first flow path diverges from the second flow path upstream of the pollutant removing means.

Suitably, the first flow path and the second flow path intersect with each other downstream of the pollutant removing means. Thus the gas in one flow path is reintroduced into the gas of the other flow path.

Suitably, the first gas flow splits from the second gas flow path at a separator for diverting pollutant to the pollutant removing means. Suitably, the separator is generally conically shaped with an opening for one of the gas flow paths therethrough.

Suitably, the first flow path diverges from the second flow path at a tube through which gas can pass. Suitably, the tube is a perforated tube.

The first and second flow paths may be in common for some of their respective passages through the arrangement, but they form discrete flow paths before intersecting downstream of the filter.

Suitably, the arrangement comprises a gas flow tube for the second flow path, which gas flow tube comprises a slot for the first gas flow path to join the second gas flow path.

Suitably, the arrangement comprises a first chamber, a second chamber and a third chamber, whereby gas enters into a first chamber, passes into a second chamber at which the first flow path diverges from the second flow path, and whereby gas can flow into the third chamber through two openings one of which comprises the pollutant removing means, and in which there is an exit for gas from the third chamber.

Suitably, the pollutant removing means comprises a filter.

Suitably, the filter comprises a regenerative filter. Suitably, the filter is electrically regenerative.

Thus, the arrangement provides a gas flow apparatus.

According to the present invention in a second aspect, there is provided a pollutant removal device for at least partly removing a pollutant from a gas flow, the device comprising a gas flow arrangement apparatus according to the first aspect of the invention.

Suitably, the device comprises means for at least partially ionising gas flow. Suitably, the ionising means comprises an electrode for electrostatic precipitation. Suitably, the electrode is mounted in the second chamber. Suitably, the electrode is mounted in the first chamber.

Suitably, the apparatus comprises a tube through which the gas stream at least partly flows, whereby the tube is at least partly porous to the gas stream.

Suitably, the tube is at least partly about the ionising means.

Suitably, the tube is perforated. Suitably, the tube comprises a plurality of holes therethrough. Suitably, the holes are evenly spaced. Suitably, the holes are evenly sized. Suitably, the perforated region of the tube is substantially annular. Suitably, the perforated region of the tube extends for a substantial length thereof.

Suitably, the tube comprises at least one slot therethrough. Suitably, a plurality of slots is provided. Suitably, the slots are substantially evenly distributed about the tube. Suitably, the at least one slot runs longitudinally along the tube.

Suitably, a major portion of the tube is porous. Alternatively a minor portion of the tube is porous.

Suitably, the tube is circular in cross-section.

Suitably, the tube comprises an inlet and an outlet.

Suitably, the cross-sectional area of the tube decreases along its length from the input to the output thereof.

Suitably, the tube is at least partly coated with a barrier coating for slowing the discharge time of charged agglomerates.

Suitably, the electrode is mounted at one end thereof only.

Suitably, the tube is located in the first and second gas flow paths. The tube acts to split the gas flows and concentrate at least one pollutant in one flow path for subsequent removal.

Suitably, the apparatus comprises a first expansion tube in fluid communication with an apparatus gas inlet. Suitably, the diverting tube extends from the first expansion tube to a second expansion tube defined by the tube. Suitably, there is a third expansion tube about the diverting tube into which gas can flow through the diverting tube. Suitably, a filter is located between (in respect of gas flow) the second and third expansion tubes.

Suitably, the device is arranged whereby at least one pollutant is biased towards the first flow path (ie a substantial majority of an input pollutant flows through the first flow path, subject to being trapped by the filter).

Suitably, a catalytic converter is provided in the second flow path.

Suitably, the electrode projects from the first chamber in to the second chamber.

Suitably, the second flow path includes a catalytic converter.

Suitably, the device is for fitting to a vehicle exhaust. Suitably, the device is for fitting in place of the silencer of a vehicle exhaust.

According to the present invention in the third aspect, there is provided an apparatus for removing pollutants from a gas stream, the apparatus comprising means for charging particulates in the gas stream and a tube through which the gas stream at least partly flows, whereby the tube is at least partly porous to the gas stream and the apparatus additionally comprises means for collecting at least one pollutant.

Suitably, the tube is at least partly about the charging means. Suitably, the charging means comprises an electrode.

Suitably, the tube is perforated. Suitably, the tube comprises a plurality of holes therethrough. Suitably, the holes are evenly spaced. Suitably, the holes are evenly sized. Suitably, the perforated region of the tube is substantially annular. Suitably, the perforated region of the tube extends for a substantial length thereof.

Suitably, the tube comprises at least one slot therethrough. Suitably, a plurality of slots is provided. Suitably, the slots are substantially evenly distributed about the tube. Suitably, the at least one slot runs longitudinally along the tube.

Suitably, a major portion of the tube is porous. Alternatively a minor portion of the tube is porous.

Suitably, the tube is circular in cross-section. Suitably, the tube comprises an inlet and an outlet.

Suitably, the cross-sectional area of the tube decreases along its length from the input to the output thereof.

Suitably, the electrode is mounted at one end thereof only.

Suitably, there is a first gas flow path from an apparatus gas inlet to an apparatus gas outlet and a second gas flow path from the apparatus gas inlet to the apparatus gas outlet. The first and second gas flow paths may be in common for a part thereof. Suitably, a filter is located in the second gas flow path. Suitably, the tube is located in the first and second gas flow paths. The tube acts to split the gas flows and concentrate at least one pollutant in one flow path for subsequent removal.

Suitably, the apparatus comprises a first expansion tube in fluid communication with an apparatus gas inlet. Suitably, the diverting tube extends from the first expansion tube to a second expansion tube defined by the tube. Suitably, there is a third expansion tube about the diverting tube into which gas can flow through the diverting tube. Suitably, a filter is located between (in respect of gas flow) the second and third expansion tubes.

Suitably, the filter comprises an electrically regenerative filter.

Suitably, the apparatus is for removing pollutants from an exhaust gas stream, preferably a vehicle exhaust gas stream.

According to the present invention in a fourth aspect, there is provided a combustion generator and an apparatus according to the second or third aspects of the invention in which exhaust gas from the generator flows to an apparatus inlet.

Suitably, the generator is an internal combustion engine.

### BRIEF DESCRIPTION OF THE DRAWINGS

The present invention will now be described, by way of example only, with reference to the drawings that follow; in which:

FIG. 1 is a schematic perspective (partly cut away) illustration of a gas flow arrangement apparatus according to an embodiment of the present invention.

FIG. 2 is a schematic perspective (partly cut away) illustration of the gas flow arrangement shown in FIG. 1 from a reverse angle.

FIG. 3 is a longitudinal cross-sectional view of the arrangement shown in FIGS. 1 and 2.

FIG. 4 is an enlarged partly cut away and sectional drawing of the filter shown in FIGS. 1 and 2.

FIG. 5 is a schematic partly cut away illustration of an embodiment of a particulate filtration device according to the present invention.

FIGS. 6 and 7 are schematic partly cut away illustrations of two further embodiments of a device according to the present invention.

FIG. 8 is a schematic longitudinal cross-sectional view of an electrode mount.

FIG. 9 is a schematic partly-sectional elevation of a gas flow arrangement apparatus according to a yet further embodiment of the present invention.

FIG. 10 is a perspective view of a second gas flow path tube and filter of FIG. 9.

FIG. 11 is a sectional view of a further electrode mounting arrangement.

FIG. 12 is a plan elevation (external walls cut away) of an apparatus according to a further embodiment of the present invention.

FIG. 13 is a side elevation of FIG. 12.

FIG. 14 is a perspective illustration of FIGS. 12 and 13.

FIG. 15 is a plan elevation (external walls cut away) of an apparatus according to a yet further embodiment of the present invention.

FIG. 16 is a perspective illustration of FIG. 15.

FIG. 17 is a plan view of a yet further embodiment of the present invention.

FIG. 18 is a side elevation of FIG. 17.

FIG. 19 is a sectional, inverted plan view corresponding to FIG. 17.

### DESCRIPTION OF THE PREFERRED EMBODIMENT

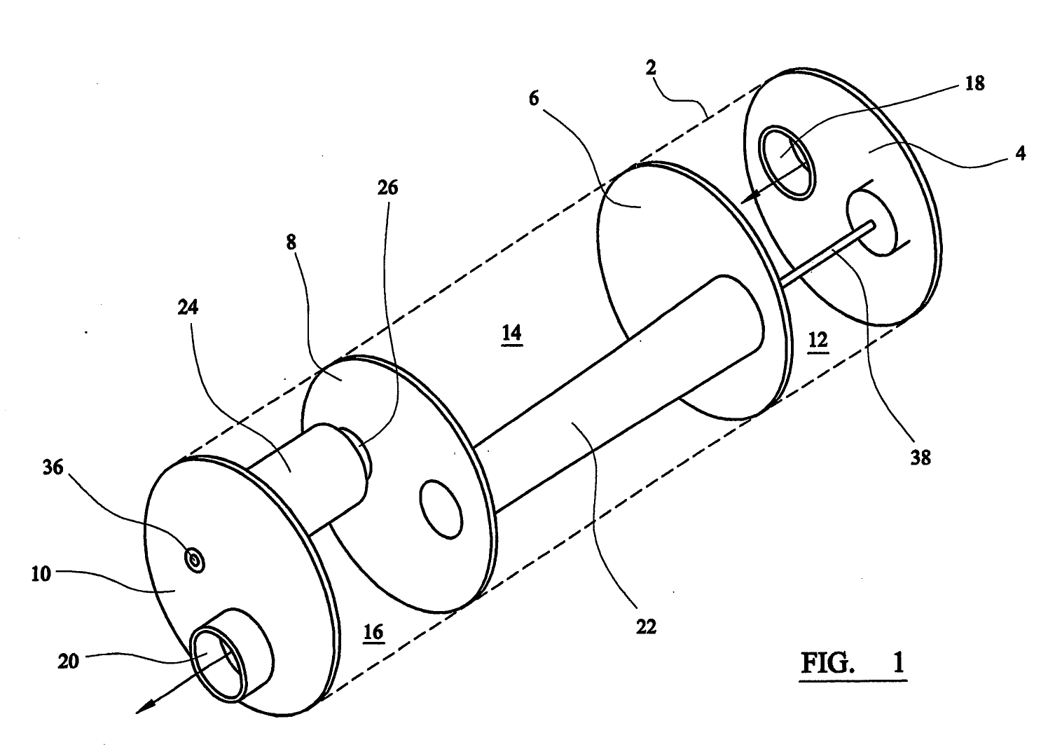

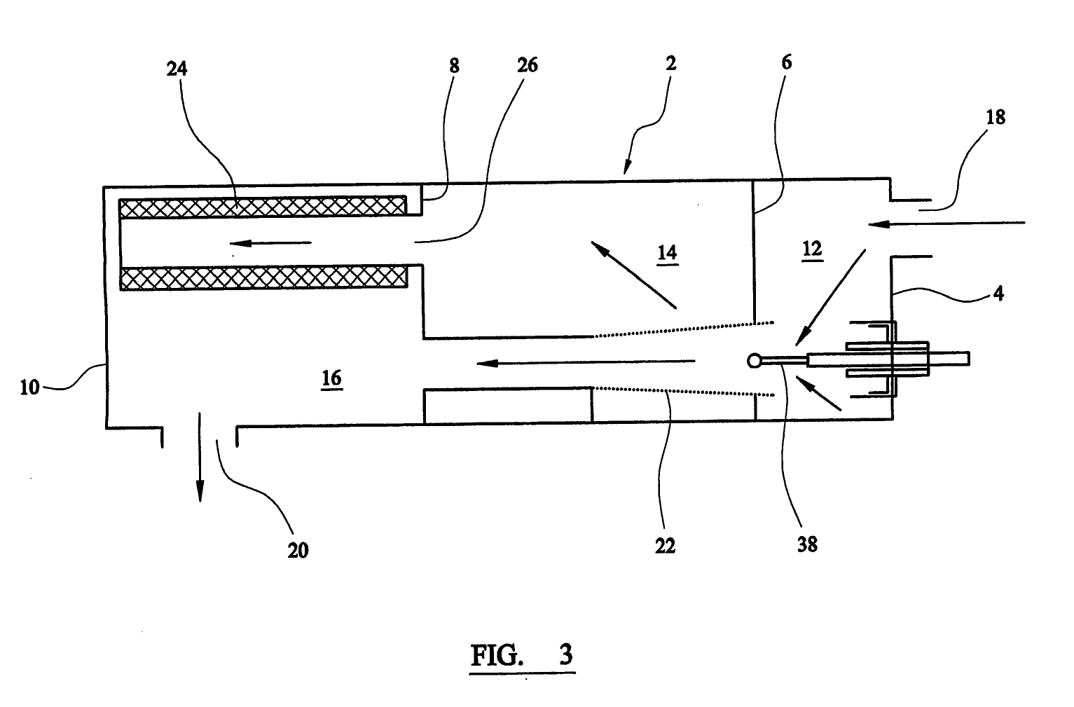

Referring to FIGS. 1-3 of the drawings that follow, there is shown a gas flow arrangement apparatus within a circular cylindrical tubular body indicated by dashed line 2. The body 2 is defined internally by wall plates 4, 6, 8 and 10 respectively into a first chamber 12, a second chamber 14 and a third chamber 16. The body 2 is provided with a gas entry tube 18 and gas exit tube 20. Gas entry tube 18 extends from the exterior wall plate 4 to first chamber 12. That is, gas enters at the entrance of 18 and exits into first chamber 12. Gas exit tube 20 extends from the exterior of wall plate 10 to third chamber 16. Additionally, there is provided a perforated tube 22 extending between first chamber 12 and third chamber 16, the perforations opening into second chamber 14. The tube 22 is highly perforated whereby in a given annulus there is more area taken up by holes than by solid. The preferred structure is substantially constant radially and longitudinally.

A filter 24 for removing pollutants from the gas stream is mounted in third chamber 16 about an opening 26 between third chamber 16 and second chamber 14.

The filter 24 is an electrically regenerative filter such as the filter identified as 3M part number SK-1739.

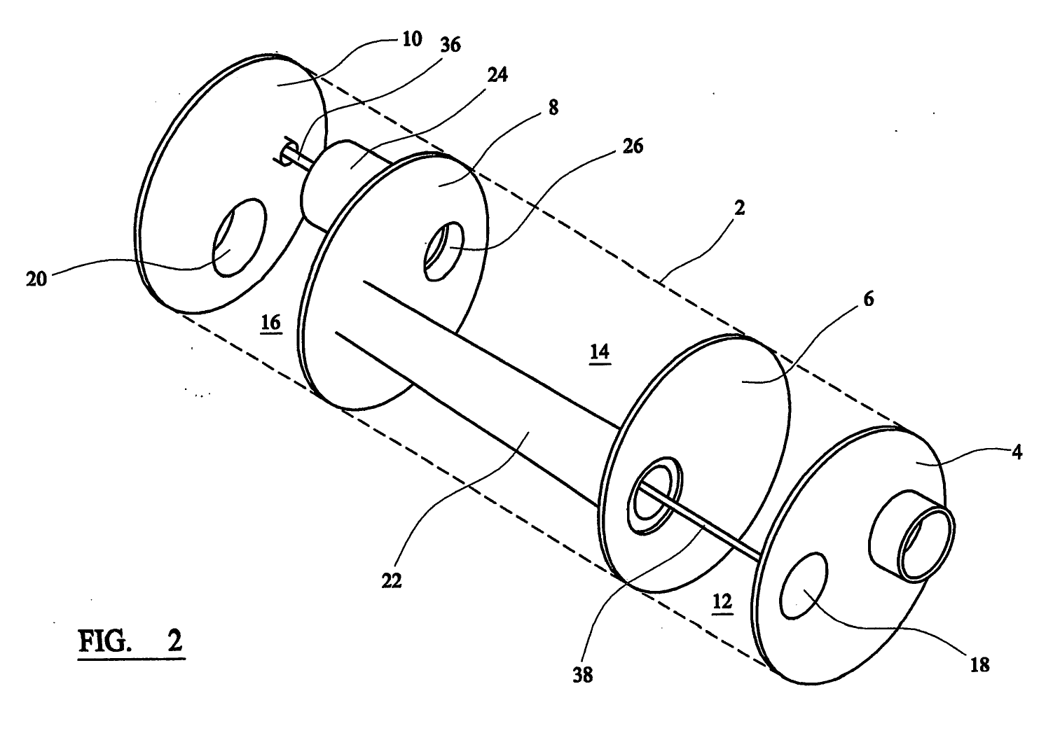

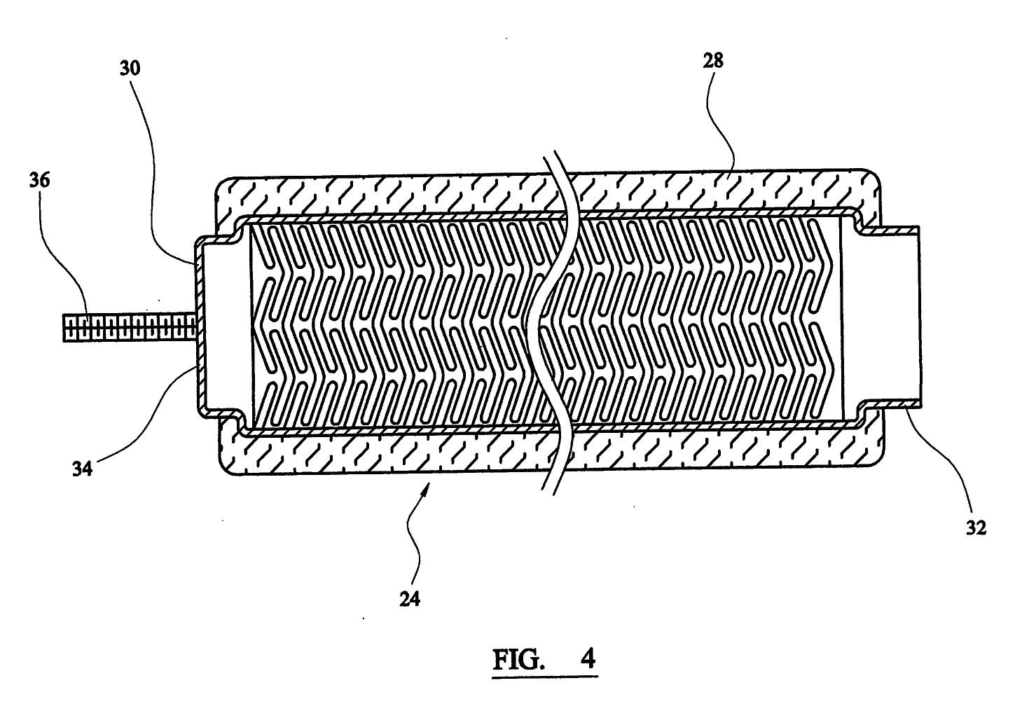

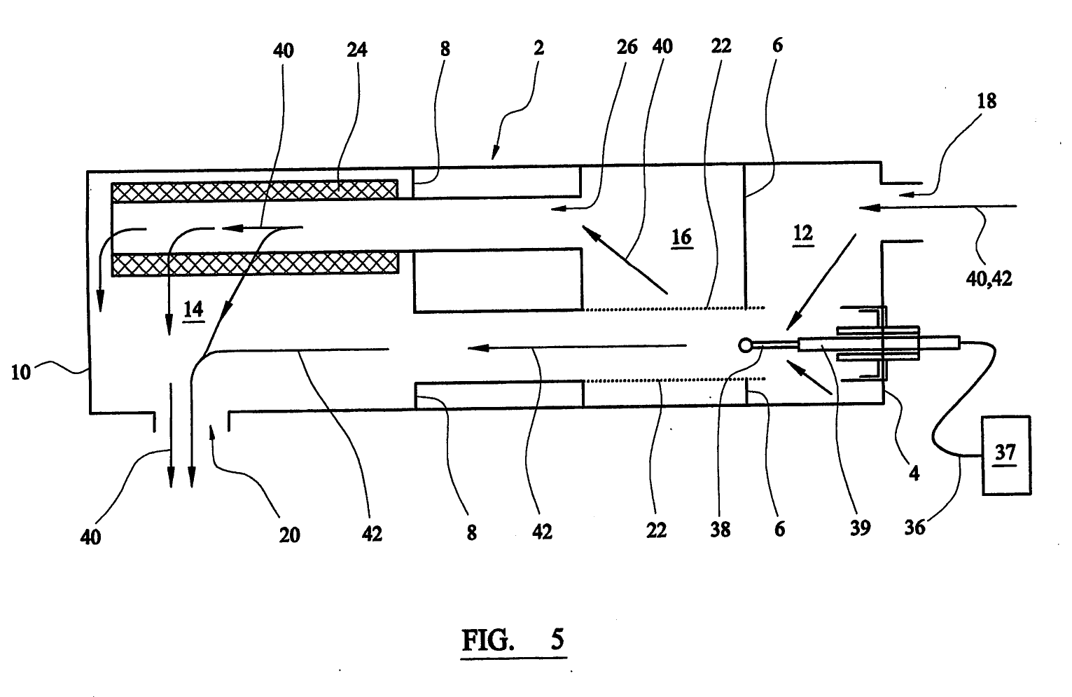

The filter 24 is shown in more detail in FIG. 4 of the drawings that follow. The filter 24 comprises a tubular outer body 28 of a NEXTEL 312 filtration mounted on a porous metallic frame 30 which is connected to earth (which may be a floating earth) at one end 32. The other end 34 provides an electrical connection 36 (see also FIGS. 1 and 2) to a power supply 37 (FIG. 5) to achieve heating and regeneration of the filter 24 as is known in the art.

An electrode 38 is mounted on wall plate 10 by a ceramic electrode mount 39 to project into the hollow interior of perforated tube 22 as shown in cross-section in relation to FIG. 4 of the drawings that follow in which corresponding reference numerals are used.

In use, pollutant eg particulate carrying gas enters the arrangement at 18 and passes into first chamber 12 from which its only route is into perforated tube 22. In operation the electrode is highly charged to between 18 kV-40 kV negative polarity d.c. to ionise or charge particulates in the gas stream forcing them through the perforated holes of the tube 22 in to second chamber 14 (under full load the potential may be about 10 kV). Additionally, it is believed that the gas becomes at least partly ionised.

The perforated tube 22 opens into third chamber 16 allowing gas to pass through exit tube 20 to exhaust. Further, gas can flow from second chamber 14 to third chamber 14 through hole 26 through filter 24. Thus filter 24 can collect particulate material. The filter 24 is regenerative so that at intervals it is electrically regenerated. This need not be on a regular basis. However, if for any reason the filter 24 does not regenerate fully or a heavy loading occurs causing back pressure between filter 24 and second chamber 14, this is compensated for because gas can still flow to exit tube 20 through perforated tube 22 and third chamber 16. Thus build up of particulates (or other pollutants) in filter 24 will not cause undue back pressure on the engine providing an exhaust stream to the gas flow arrangement. As a result, the problem of back pressure encountered in relation to prior art filtration arrangements is overcome by embodiments of the present invention and there is provided a geometrically efficient and compact gas flow arrangement.

Thus embodiments of the present invention provide a first gas flow path 40 (FIG. 5) from gas entrance 18 to gas exit 20 via first chamber 12, tube 22, third chamber 16 through filter 24 and second chamber 14 and a second gas flow path 42 (FIG. 4) from gas entrance 18 to gas exit 20 via first chamber 12, tube 22 and second chamber 14 which is other than through the filter 24.

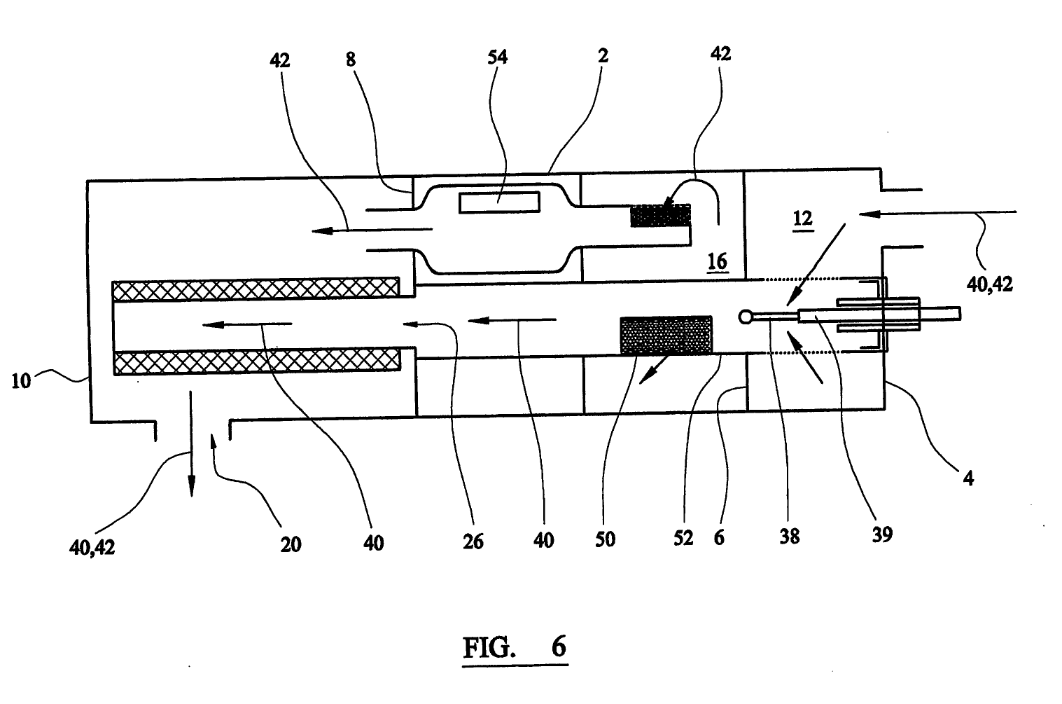

Referring to FIG. 6 of the drawings that follow, there is shown another embodiment of a gas flow arrangement and pollutant removal device according to the present invention. The arrangement and device is similar to that described in relation to FIG. 5 (and similar reference numerals are used for corresponding integers), except that the first gas flow path 40 through filter 24 is generally straight on, ie the flow path does not diverge substantially from the path of the tube 22 to the filter 24 and the second gas flow path 42 follows the more tortuous route as shown.

To bias the particulate pollutants to follow first gas flow path 40 at FIG. 6, instead of a highly perforated tube 22 (considered over the length at tube 22) a small area 50 of perforated tube 52 with a lower hole density is provided. The less perforated tube 52 is not annular, it just occupies a slot in the tube. As the effect of the corona discharge electrode 38 with the floating earth of the tube 52 is to draw particulates to the side (tube 52) walls where they tend to agglomerate, by providing less open area for the agglomerated particulate to pass through, it is less likely that particulates will follow the second flow path 42.

Another difference in the FIG. 6 embodiment is the provision of a catalytic converter 54 in the second flow path 42 for the removal of hydrocarbons from the gas stream.

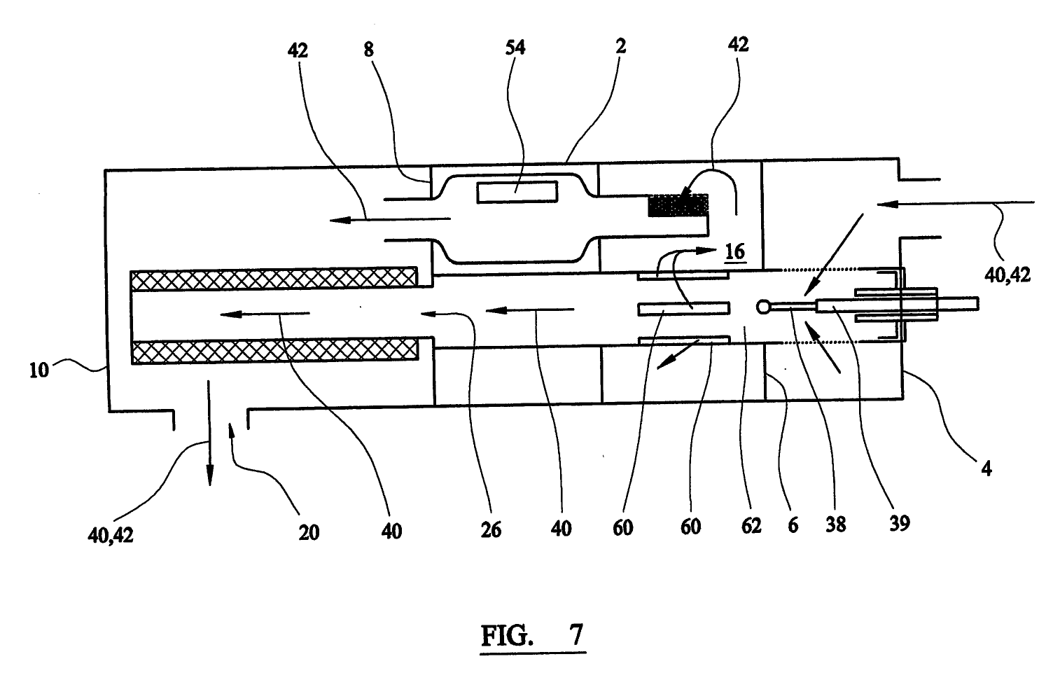

FIG. 7 is a yet further embodiment of the present invention substantially similar to the embodiment of FIG. 6, except that four equally spaced longitudinal slits 60 are provided over a substantial minority of the surface area of tube 62.

Referring to FIG. 8 of the drawings that follow, the electrode mount 39 is shown in more detail. The electrode mount 39 is a one piece ceramic construction having a longitudinal hole 64 therethrough for the electrode 38 (not shown in FIG. 8). The electrode projects from distal end 66 and is connected to a power source at end 68. The electrode mount 39 is held by a bracket (not shown) about shoulder 70. Protrusions 72a, 72b and 72c project from the exterior of electrode mount 39. The protrusions 72 are partly hollow, rebated conical shapes that provide a tortuous route from the electrode 38 projecting from distal end 66 to earth to reduce leakage.

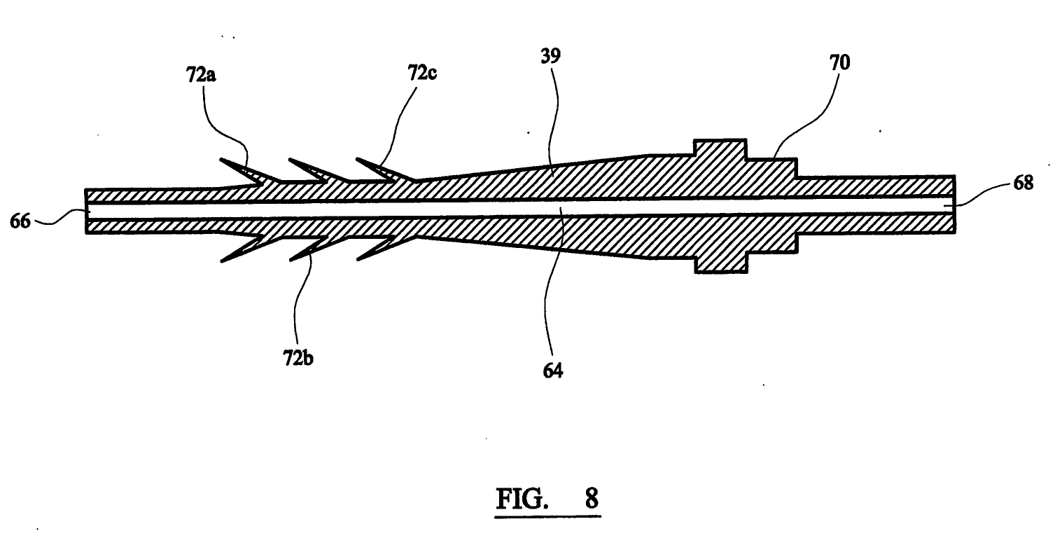

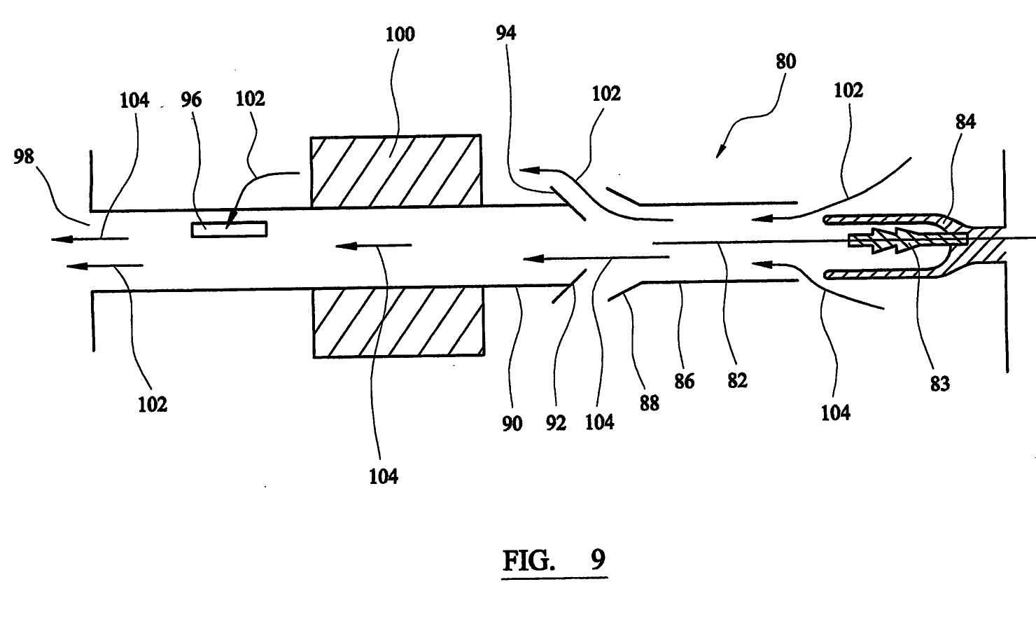

Referring to FIGS. 9 and 10 of the drawings that follow, there is shown a gas flow arrangement apparatus 80 for use in a pollutant removal device in which outer walls are not shown for clarity. The apparatus 80 comprises an ionising electrode 82 in an electrode mount 83, partly surrounded by an electrode hood 84. Electrode 82 extends into an electrode tube 86 which terminates in an outwardly diverging end 88. Spaced from electrode tube 86 is a second gas flow path tube 90 having a generally conically shaped entrance 92 with a central opening 94. The opening 94 is substantially inside the diameter of the walls of electrode tube 84. Tube 90 terminates in an exit 98. About tube 90 is a catalytic filter 100 for at least partly removing pollutants from a gas stream passing therethrough.

Operation of the embodiment of FIGS. 9 and 10 is similar to that of the embodiments described above. Exhaust gases, carrying pollutants, enter the apparatus 90 upstream of electrode 82, and pass over hood 84 which serves to help prevent pollutant build up on electrode 82. The electrode 82 is charged to ionise pollutants in the gas flow, which pollutants are therefore attracted to the walls of electrode tube 86 as they flow downstream, leaving relatively cleaner gas towards the centre of the flowstream. The conical opening of second gas flow path tube 90 serves to help deflect pollutant into a first gas flow path (indicated schematically by arrows labelled 102, while the second gas flow path is indicated by arrows labelled 104). The first gas flow path 102 passes through filter 100, which removes some pollutants, and rejoins second gas flow path 104 through a slot 96 in tube 172 downstream to the filter 100. The slot 96 is relatively small compared to the surface area of tube 90. The pressure difference either side of slot 96 is believed to encourage now relatively cleaner gas from the first gas flow path downstream of filter 100 to rejoin the second gas flow path. Second gas flow path 104 passes through second gas flow path tube 90 carrying relatively cleaner gas. The rejoined gas streams, pass out of the apparatus at exit 98.

In any of the embodiments a resistive organic barrier coating may be provided over the inner surface of the tube (22 in FIG. 1) downstream of the beginning of the electrode. The barrier coating is preferably over substantially all of the inner surface of the tube. The coating is TLHB/02 available from Camcoat Performance Coatings on 127 Hoyle Street, Bewsey Industrial Estate, Warrington, WA5 5LR, United Kingdom. It is believed that by reducing the discharge rate of the agglomerated particulates along the tube by providing the coating, the particulates are more likely to stay in the vicinity of the tube.

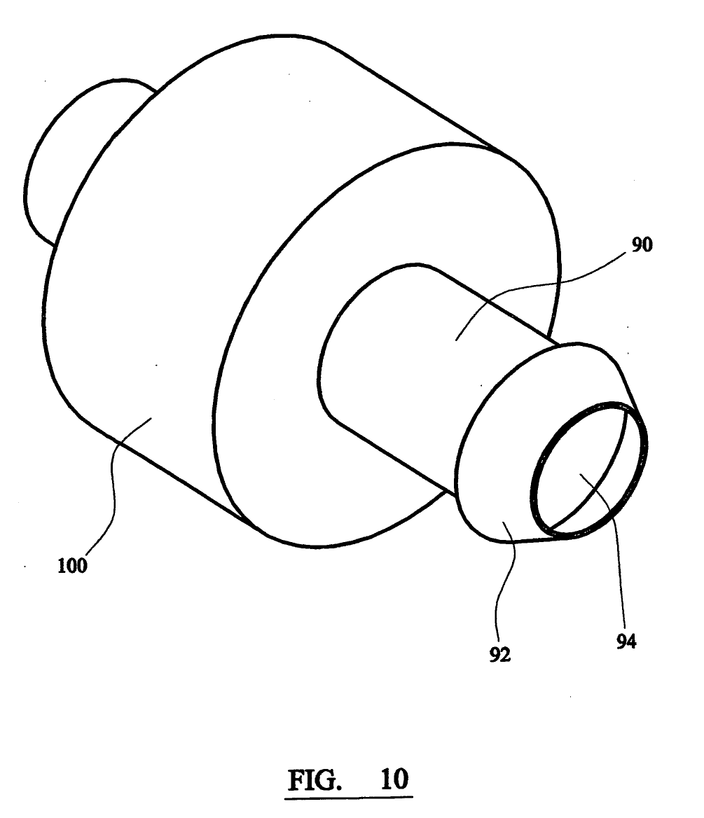

Referring to FIG. 11 of the drawings that follow, an alternative electrode mounting arrangement is shown. Both the electrode mount 83 and electrode hood 84 are formed from a ceramic high purity alumina material, sold under the trade mark SINTOX FF which is believed to have a dielectric strength of between 30 and 40 kV/mm.

The electrode mount 83 comprises a first ceramic mounting portion 88 and a second ceramic mounting portion 90 mounted in bore 86. The second ceramic mounting portion 90 is of a reduced external diameter compared with the first ceramic mounting portion. The electrode mount 83 can be formed from a single ceramic. Thus the electrode mount 83 has a portion of a first diameter and a portion of a lesser diameter towards the distal end (from which the electrode projects) thereof. The second portion 90 of second diameter extends a substantial distance beyond hood 84 typically at least 30mm.

The hood 84 protects a substantial part of the electrode (mounted in central bore 86) from the inflow of pollutants containing gas thus minimising the risk of shorting. However, it is believed that at least a 30mm length of the electrode needs to project beyond the hood. It is noted that the gas inlet is not around the electrode but rather alongside it and can be protected from it by the hood 84.

The electrode mount and hood can be glazed to reduce pitting of the surface and hence the build up of articulates thereon. The glaze acts as a means for smoothing the surface of the electrode mount.

It is noted that although the maximum exterior diameter of each generally conically shaped protrusion 83 decreases in a downstream direction, the minimum internal diameter are substantially the same ±10%. This is believed to provide additional burn-off points if required.

The alumina content of hood and mount is typically at least 80%, normally at least 90%, preferably more than 95%, more preferably more than 97% and most preferably more than 99%.

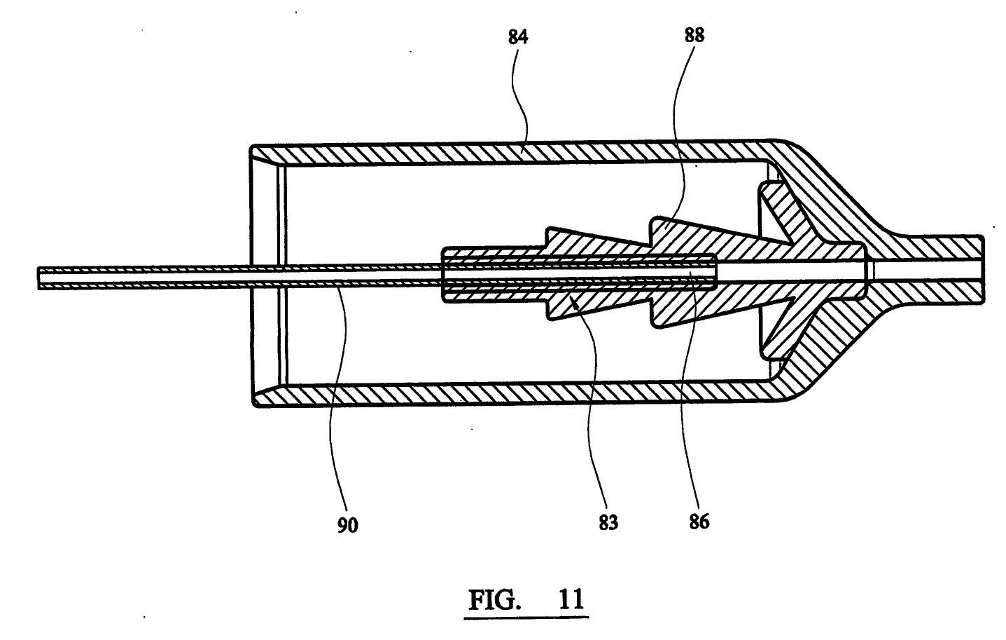

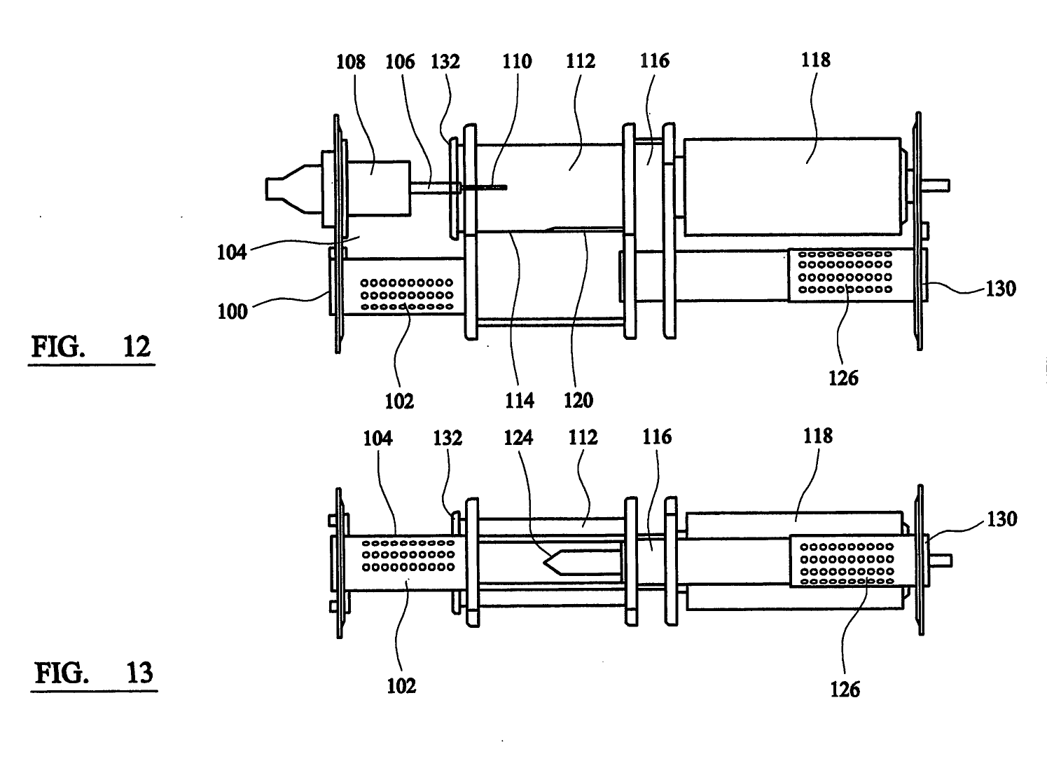

Referring to FIGS. 12-14 of the drawings that follow, there is shown a further embodiment of a gas flow arrangement and apparatus for removing pollutants according to the present invention. In the FIGS. 12-14 embodiment, exhaust gas enters through an inlet 100 into a perforated baffle tube 102 from which all of the entering exhaust gases flow into first chamber 104. In chamber 104, electrode mount 106 over a substantial part of which lies hood 108 mounts an electrode 110 which projects into a second chamber 112 defined by field tube 114. Field tube 114 includes an opening in its end to an intermediate chamber 116, the only exit from which is into filter 118. An alternative flow path is provided via an opening 120 in the wall of field tube 114. The opening 120 is provided with an upstanding lip 122 projecting inwardly into the field tube 114 at at least the upstream portion thereof, but in this embodiment along the full length thereof. Further, the opening 120 comprises a generally V-shaped upstanding leading edge 124 at an upstream end thereof.

Fluid flow path leads from field tube 114 via opening 120 leads to a perforated exit tube 126. Perforations 128 in exit tube 126 permit gas passing through filter 118 to re-enter the diverted gas flow leading to exit 130.

It is noted that the leading edge 132 of field tube 114 comprises a returned edge that is curved back on itself whereby the exterior edge of the leading edge 132 of field tube 114 is configured relative to the electrode whereby something else lies between it and electrode and/or electrode mount. In this case, another part of the field tube lies between the external edge and both of the electrode mount 106 and electrode 110.

Upstanding lip 122 and leading edge 124 help to divert particulates away from opening 120 from which it is intended that cleaner gas flows. Together, upstanding lip 122 and leading edge 124 act as means for diverting particulates away from the opening 120.

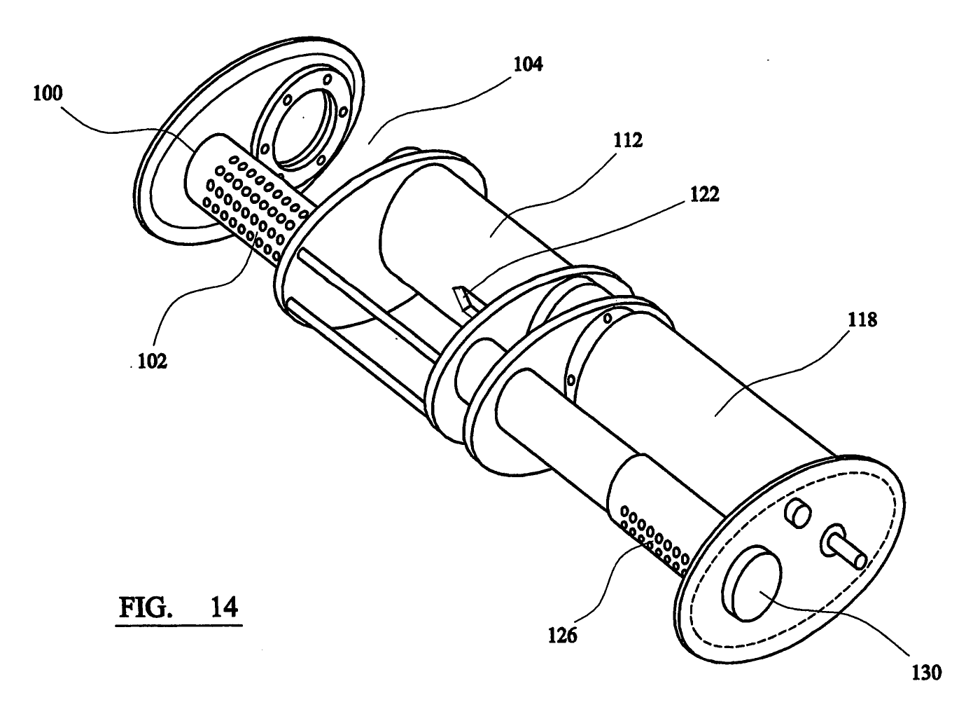

The electrode, electrode mount and hood are not shown in FIG. 15.

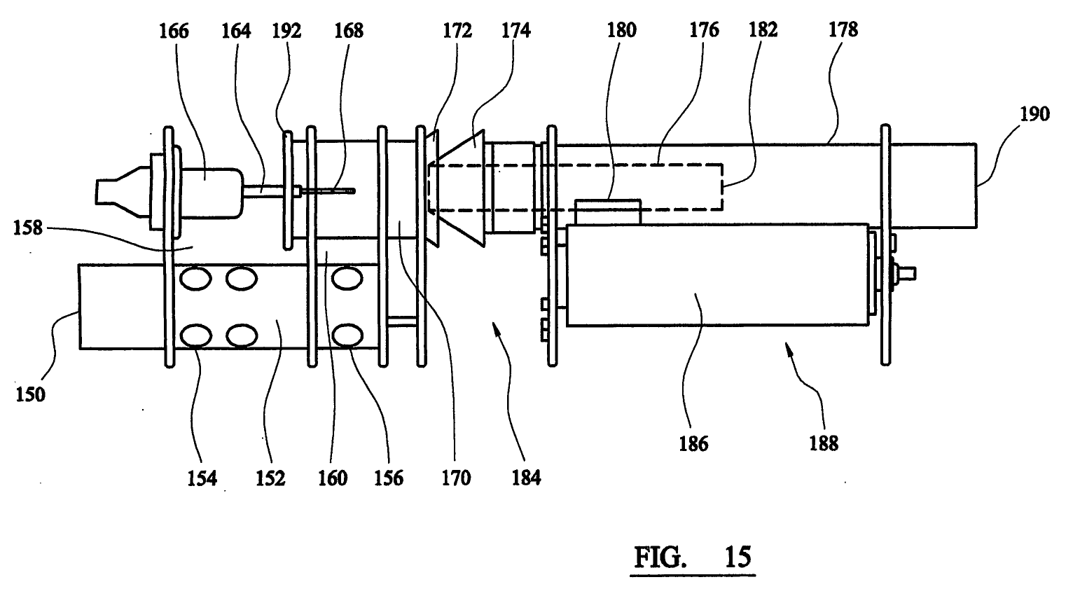

Referring to FIGS. 15 and 16 of the drawings that follow, there is shown a further gas flow arrangement apparatus and apparatus for removing pollutants according to the present invention.

In FIGS. 15 and 16, the apparatus comprises an inlet 150 into which exhaust gas flows into a baffle chamber 152 having first exit ports 154 and second exit ports 156. First exit ports 154 exit to first clamber 158. Second exit ports 156 exit into an intermediate chamber 160 having holes 162 permitting the flow of gas back into first chamber 158. An electrode mount 164 (FIG. 15 only), covered for a substantial part thereof by hood 166 (FIG. 15 only), is provided in first chamber 158 for mounting of an electrode 168 (FIG. 15 only) within a field tube 170. At its downstream end, field tube 170 terminates in an outwardly diverging portion 172 adjacent a generally conical portion 174 within which is a tube 176 extending to an exit tube 178.

In exit tube 178 is provided an opening 180 prior to the exit 182 of tube 176.

In use, exhaust gas flows in via inlet 150 into field tube 170 via first chamber 158. Particulates in the field tube are charged by electrode 168 and tend towards the walls of field tube 170. Thus the particulates are diverted from the central flow of gas through field tube 170. The central flow of gas enters tube 176 into exit tube 178. Other gas bearing a higher loading of particulates exits towards the periphery of field tube 170 and therefore tends not to enter tube 176. The generally conical portion 174 acts as a deflector for the particulates encouraging them not to enter tube 176. The particulate laden gas exiting field tube 170 other than through tube 176 enters a second intermediate chamber 184 leading to filter 186. Gas exiting filter 186 can only exit the apparatus via opening 180 and into exit tube 178. However the gas exiting filter 186 tends to be at a low velocity compared to the high velocity gas exiting tube 176. The pressure differential causes the gas in third chamber 188 about filter 186 to be drawn through opening 180 into exit tube 178 and hence to outlet 190.

Field tube 170 may include a curved leading edge 192 as described above in relation to FIGS. 12-14.

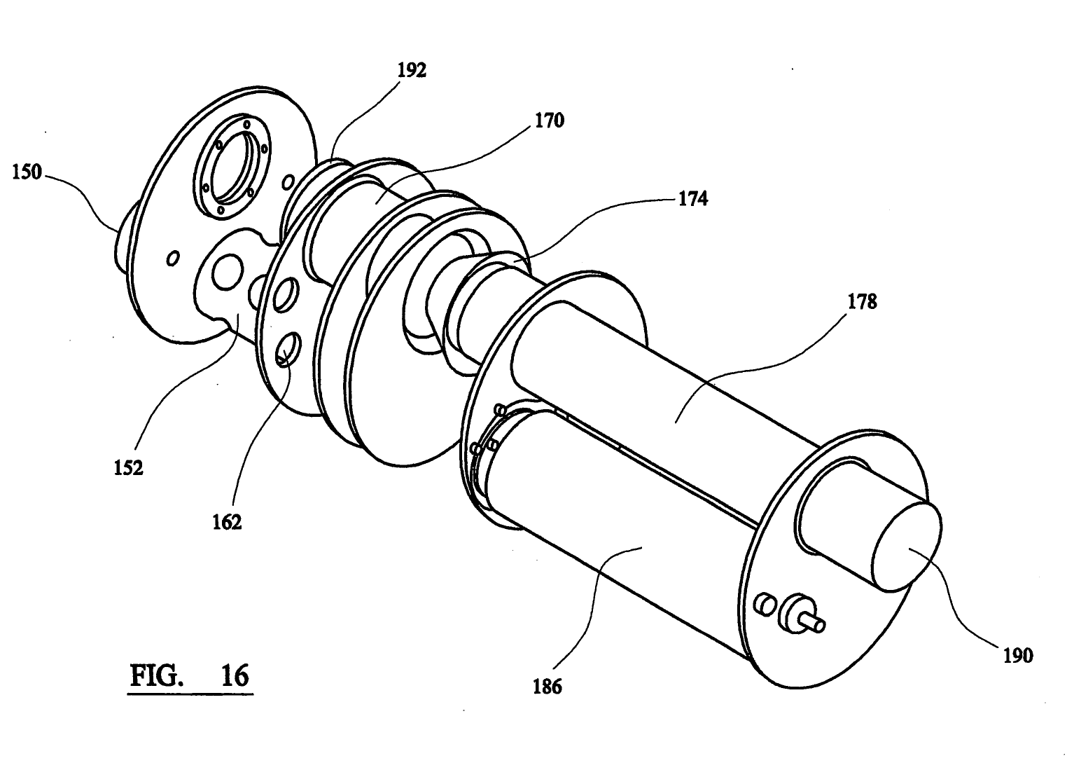

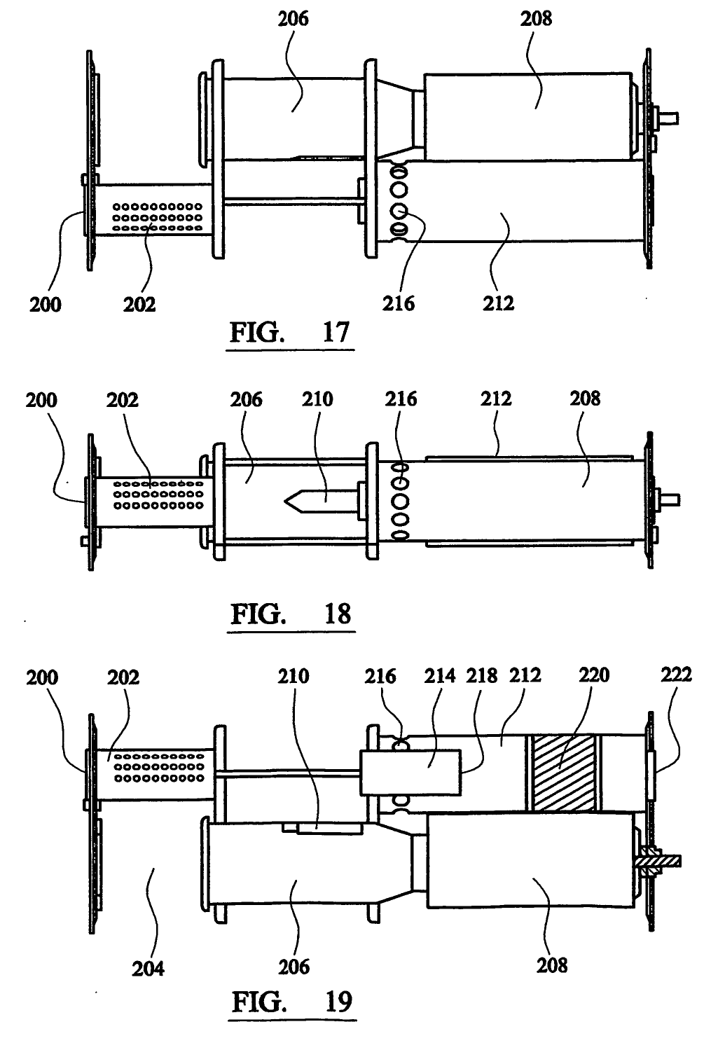

FIGS. 17 and 18 show a further embodiment of the present invention. In FIGS. 17 and 18, for clarity the electrode mount and electrode are not shown.

Referring to FIGS. 17 and 18, there is shown a gas inlet into a perforated expansion chamber 202, from which all the input gas flows into a first chamber 204 and from there into field tube 206 which leads to filter 208. Alternatively, through opening 210 in field tube 206 gas can flow to exit tube 212 in which there is a concentrically mounted flow tube 214 and in an exterior wall of which an opening 216 mounted behind (relative to the gas flow) the exit 218 of tube 214. In exit tube 212 a catalytic body 220, acting as a catalytic converter, optionally can be mounted. In use, gas enters through inlet 200, passes through expansion tube 202 into first chamber 204 and then into field tube 206 in which particulates in the gas flow are charged. Charged particulates tend towards the side wall of field tube 206 and an upstanding lip may be provided around 210 to divert particulates therefrom. Particulates proceeding from field tube 206 to filter 208 are filtered and the gas flow can continue towards exit 222 via holes 216 into exit 212.

Although the first and second gas flow streams are shown separately in the same tube or area of the apparatus, this is for explanatory purposes only and it will be appreciated that in these regions the gas flows are intermingled.

It is noted that there may be a plurality of devices, a plurality of filters and/or a plurality of catalytic converters.

Instead of using standard direct current as described above, high frequency superimposed a.c can be used.

The reduced gas flow through the filter when compared with a corresponding device in which all of the input gas stream flows through the filter makes the electrical regeneration of the filter more efficient because the thermal effect of the gas flow is correspondingly reduced.

Preferred embodiments of the present invention find particular benefit in the application of pollutant, especially particulate removal from exhaust gas streams, especially of internal combustion engines. For such engines the arrangement can be mounted in place of the vehicle silencer to avoid taking up unnecessary space. The device may be upstream or downstream of a catalytic converter.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A gas flow arrangement apparatus comprising a gas entrance and a gas exit, a first flow path from the gas entrance to the gas exit through a means for at least partly removing at least one pollutant from a gas flow stream and second flow path from the gas entrance to the gas exit other than through the removing means.

2. A gas flow arrangement apparatus according to claim 1, in which the gas flow path passing through the pollutant removing means intersects the first gas flow.

3. A gas flow arrangement apparatus according to claim 1, in which the first flow path diverges from the second flow path upstream of the pollutant removing means.

4. A gas flow arrangement apparatus according to claim 1, in which the first flow path and the second flow path intersect with each other downstream of the pollutant removing means.

5. A gas flow arrangement apparatus according to claim 1, in which the first gas flow splits from the second gas flow path at a separator for diverting pollutant to the pollutant removing means.

6. A gas flow arrangement apparatus according to claim 5, in which the separator is generally conically shaped with an opening for one of the gas flow paths therethrough.

7. A gas flow arrangement apparatus according to claim 1, in which the first flow path diverges from the second flow path at a tube through which gas can pass.

8. A gas flow arrangement apparatus according to claim 7, in which the tube is a perforated tube.

9. A gas flow arrangement apparatus according to claim 1, in which the arrangement comprises a gas flow tube for the second flow path, which gas flow tube comprises a slot for the first gas flow path to join the second gas flow path.

10. A gas flow arrangement apparatus according to claim 1, in which the arrangement comprises a first chamber, a second chamber and a third chamber, whereby gas enters into a first chamber, passes into a second chamber at which the first flow path diverges from the second flow path, and whereby gas can flow into the third chamber through two openings one of which comprises the pollutant removing means, and in which there is an exit for gas from the third chamber.

11. A gas flow arrangement apparatus according to claim 1, in which the pollutant removing means comprises a filter.

12. A gas flow arrangement apparatus according to claim 11, in which the filter comprises a regenerative filter.

13. A gas flow arrangement apparatus according to claim 12, in which the filter is electrically regenerative.

14. A pollutant removal device for at least partly removing a pollutant from a gas flow, the device comprising a gas flow arrangement apparatus comprising a gas entrance and a gas exit, a first flow path from the gas entrance to the gas exit through a means for at least partly removing at least one pollutant from a gas flow stream and second flow path from the gas entrance to the gas exit other than through the removing means.

15. A pollutant removal device according to claim 14, in which the device comprises means for at least partially ionizing gas flow.

16. A pollutant removal device according to claim 15, in which the ionizing means comprises an electrode for electrostatic precipitation.

17. A pollutant removal device according to claim 16, in which the electrode is mounted in the second chamber.

18. A pollutant removal device according to claim 17, in which the electrode is mounted in the first chamber.

19. A pollutant removal device according to claim 14, in which the apparatus comprises a tube through which the gas stream at least partly flows, whereby the tube is at least partly porous to the gas stream.

20. A pollutant removal device according to claim 15 in which the apparatus comprises a tube through which the gas stream at least partly flows, whereby the tube is at least partly porous to the gas stream, and in which the tube is at least partly about the means.

21. A pollutant removal device according to claim 19, in which the tube is perforated.

22. A pollutant removal device according to claim 21, in which the tube comprises a plurality of holes therethrough.

23. A pollutant removal device according to claim 22, in which the holes are evenly spaced.

24. A pollutant removal device according to claim 22, in which the holes are evenly sized.

25. A pollutant removal device according to claim 21, in which the perforated region of the tube is substantially annular.

26. A pollutant removal device according to claim 21, in which the perforated region of the tube extends for a substantial length thereof.

27. A pollutant removal device according to claim 19, in which the tube comprises at least one slot therethrough.

28. A pollutant removal device according to claim 27, in which a plurality of slots is provided.

29. A pollutant removal device according to claim 28, in which the slots are substantially evenly distributed about the tube.

30. A pollutant removal device according to claim 27, in which the at least one slot runs longitudinally along the tube.

31. A pollutant removal device according to claim 19, in which the tube is circular in cross-section.

32. A pollutant removal device according to claim 19, in which the tube comprises an inlet and an outlet.

33. A pollutant removal device according to claim 32, in which the cross-sectional area of the tube decreases along its length from the input to the output thereof.

34. A pollutant removal device according to claim 20, in which the tube is at least partly coated with a barrier coating for slowing the discharge time of charged agglomerates.

35. A pollutant removal device according to claim 16, in which the electrode is mounted at one end thereof only.

36. A pollutant removal device according to claim 20, in which the tube is located in the first and second gas flow paths.

37. A pollutant removal device according to claim 14, in which the apparatus comprises a first expansion tube in fluid communication with an apparatus gas inlet.

38. A pollutant removal device according to claim 37, in which a diverting tube extends from the first expansion tube to a second expansion tube defined by the tube.

39. A pollutant removal device according to claim 38, in which there is a third expansion tube about the diverting tube into which gas can flow through the diverting tube.

40. A pollutant removal device according to claim 38, in which a filter is located between (in respect of gas flow) the second and third expansion tubes.

41. A pollutant removal device according to claim 14, in which the device is arranged whereby at least one pollutant is biased towards the first flow path.

42. A pollutant removal device according to claim 14, in which a catalytic converter is provided in the second flow path.

43. A pollutant removal device according to claim 14, in which the device is for fitting to a vehicle exhaust.

44. A pollutant removal device according to claim 43, in which the device is for fitting in place of the silencer of a vehicle exhaust.

45-74. (canceled)

75. A combustion generator comprising an apparatus for removing pollutants from a gas stream, the apparatus comprising means for charging particulates in the gas stream and a tube through which the gas stream at least partly flows, whereby the tube is at least partly porous to the gas stream and the apparatus additionally comprises means for collecting at least one pollutant, in which exhaust gas from the generator flows to an apparatus inlet.

76. A combustion generator according to claim 75, in which the generator is an internal combustion engine.
